(19) United States
(12) Patent Application Publication
(10) Pub. No.: US 2025/0372728 A1
(43) Pub. Date: Dec. 4, 2025

(54) ELECTRODE ASSEMBLY AND METHOD FOR MANUFACTURING SAME

(71) Applicant: SAMSUNG SDI CO., LTD., Yongin-Si Gyeonggi-do (KR)

(72) Inventor: Minseung KANG, Yongin-Si (KR)

(21) Appl. No.: 19/007,354

(22) Filed: Dec. 31, 2024

(30) Foreign Application Priority Data
Jun. 4, 2024 (KR) 10-2024-0073354

(51) Int. Cl. H01M 10/42; H01M 10/04; H01M 50/105; H01M 50/531; H01M 50/586

(52) U.S. Cl. CPC H01M 10/4235; H01M 10/0431; H01M 50/531; H01M 50/586; H01M 50/105

(57) ABSTRACT

An electrode assembly includes a first electrode, an outer separator on the first electrode, a second electrode on the outer separator, and an inner separator on the second electrode, wherein a protection member is at an end of one side of the first electrode, and a position of the protection member is at a curved portion of the first electrode in a wound state.

### CROSS-REFERENCE TO RELATED APPLICATION

The present application claims priority to and the benefit of Korean Application No. 10-2024-0073354, filed on Jun. 4, 2024, in the Korean Intellectual Property Office, the entire disclosure of which is incorporated herein by reference.

### BACKGROUND

### 1. Field

Aspects of embodiments of the present disclosure relate to an electrode assembly and a method for manufacturing the same.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Due to excellent electrical characteristics of secondary batteries, the secondary batteries are used in a variety of environments. However, during the charging and discharging process of the secondary batteries, the volume of the jelly roll of the secondary batteries may expand or contract due to a change in chemical energy while ions are moved inside the batteries and electrical energy is transmitted. The repetitive contraction and expansion that occurs during the charging and discharging process shortens the lifespan of the batteries due to mechanical stress unevenly applied to the interior of the secondary batteries and leads to a degradation in battery performance through structural loss.

In particular, in batteries manufactured by winding electrode assemblies, for example, pouch-type batteries, the tension in a bent portion positioned on a side surface increases due to the contraction and expansion of jelly roll during the charging and discharging process after assembling of cells. Accordingly, cracks occur due to stretching of an outer electrode substrate.

The above information disclosed in this Background section is for enhancement of understanding of the background of the present disclosure, and therefore, it may contain information that does not constitute related (or prior) art.

### SUMMARY

Aspects of embodiments of the present disclosure are directed to an electrode assembly and a battery including the same.

The above information disclosed in this Background section is for enhancement of understanding of the background of the present disclosure, and therefore, it may contain information that does not constitute related (or prior) art.

Thus, to solve the technical problems, aspects of some embodiments of the present disclosure provide an electrode assembly including: a first electrode; an outer separator on the first electrode; a second electrode on the outer separator; and an inner separator on the second electrode, wherein a protection member is at an end of one side of the first electrode, and a position of the protection member is at a curved portion of the first electrode in a wound state.

In some embodiments, the protection member is on an inner surface of the first electrode facing the outer separator.

In some embodiments, the protection member is positioned over an entirety of the curved portion of the first electrode.

In some embodiments, the protection member extends from a position spaced 5 mm or more from a starting point of the curved portion to an ending point of the curved portion.

In some embodiments, a length of the protection member is about 20 mm to

about 24 mm.

In some embodiments, the protection member is positioned over an entire region of the first electrode in a width direction.

In some embodiments, the protection member includes a central portion and an outer portion, and a thickness of the protection member increases as a distance from the central portion increases toward the outer portion along a winding direction.

In some embodiments, the electrode assembly further includes a first electrode tab on an outer surface of the first electrode.

In some embodiments, the protection member does not overlap the first electrode tab with respect to a cross section of the electrode assembly wound therearound.

In some embodiments, the electrode assembly further includes an insulating member on the inner surface of the first electrode.

In some embodiments, the insulating member faces an end of one side of the second electrode with the outer separator therebetween.

In some embodiments, the second electrode is shorter than the first electrode and the separator.

In some embodiments, an end of one side of the second electrode overlaps the insulating member with respect to a cross section of the electrode assembly wound therearound.

In some embodiments, the electrode assembly further includes a second electrode tab on one surface of the second electrode, wherein the second electrode tab overlaps the insulating member with respect to the cross section of the electrode assembly wound therearound.

In some embodiments, the protection member is a tape including an adhesive.

In some embodiments, the tape includes any one of polypropylene (PP), polyimide (PI), polyethylene propylene (PEP), or any combination thereof.

According to some embodiments of the present disclosure, there is provided a secondary battery including the electrode assembly as described above.

According to some embodiments of the present disclosure, there is provided a method of manufacturing an electrode assembly the method including:
positioning a protection member on an end of one side of a first electrode; producing the electrode assembly by sequentially stacking the first electrode, an outer separator, a second electrode, and an inner separator; and producing a jelly roll by winding the electrode assembly, wherein a position of the protection member is at a curved portion of the first electrode in a wound state.

In some embodiments, the protection member includes a central portion and an outer portion, and a thickness of the protection member increases as a distance from the central portion increases toward the outer portion along a winding direction.

In some embodiments, the electrode assembly further includes a first electrode tab, and the protection member does not overlap the first electrode tab with respect to a cross section of the electrode assembly wound therearound.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 illustrates an electrode assembly and a secondary battery according to some embodiments of the present disclosure.

FIG. 2 illustrates a plan view schematically showing the electrode assembly before being wound according to some embodiments of the present disclosure.

FIG. 3 illustrates a plan view showing a cross section of an electrode assembly according to some embodiments of the present disclosure.

FIG. 4 illustrates a plan view showing a cross section of an electrode assembly according to some other embodiments of the present disclosure.

FIG. 5 illustrates an expanded view of a first electrode and a second electrode according to some embodiments of the present disclosure.

FIG. 6 illustrates a plan view showing a cross section of a protection member according to some embodiments of the present disclosure.

FIGS. 7 to 9 illustrate a first electrode and a protection member according to some embodiments of the present disclosure.

FIG. 10 illustrates a flowchart showing an example of a method for manufacturing an electrode assembly according to the present disclosure.

FIG. 11 illustrates cracks (damage) occurring in a secondary battery.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, it will be understood that when an element is referred to as being “coupled,” “linked” or “connected” to another element, the elements may be directly “coupled,” “linked” or “connected” to each other, or an intervening element may be present therebetween, through which the element may be “coupled,” “linked” or “connected” to another element. In addition, when a part is referred to as being “electrically coupled” to another part, the part can be directly connected to another part or an intervening part may be present therebetween such that the part and another part are indirectly connected to each other.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

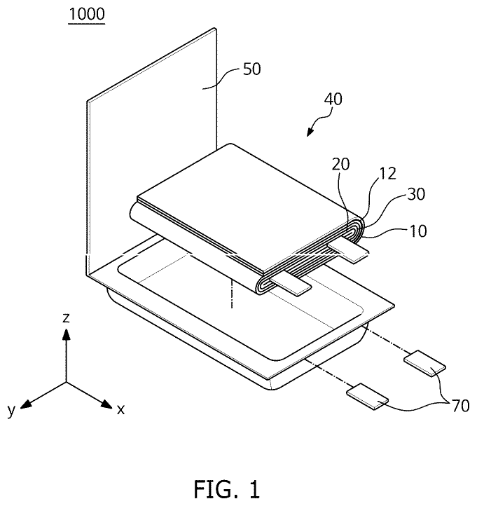

FIG. 1 illustrates an electrode assembly 40 and a secondary battery 1000 according to some embodiments of the present disclosure.

Referring to FIG. 1, the secondary battery 1000 according to some embodiments of the present disclosure may include the electrode assembly 40 according to the present disclosure. For example, the secondary battery 1000 may include the electrode assembly 40 and a case 50 in which the electrode assembly 40 is embedded.

The electrode assembly 40 may include a positive electrode 10, a negative electrode 20, and a separator 30 disposed between the positive electrode 10 and the negative electrode 20. The separator 30 may include an outer separator and an inner separator. Based on the wound electrode assembly 40, the side relatively close to the center of the electrode assembly may refer to the inside, and the side relatively far from the center of the electrode assembly may refer to the outside.

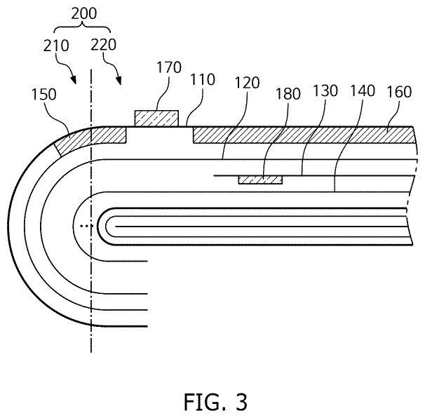

In some embodiments, a protection member 12 may be disposed at an end of one side of the positive electrode 10, and the position thereof may belong to a curved portion of the wound positive electrode 10. This is described further below with reference to FIG. 3.

The case 50 may form the overall appearance of the secondary battery 1000 and may be formed of a polymer or a conductive metal such as aluminum, an aluminum alloy, stainless steel (e.g., SUS), or nickel-plated steel. For example, the case 50 may provide a space in which the electrode assembly 40 is accommodated. In examples in which the secondary battery 1000 is a pouch battery, the case 50 may have a pouch shape.

For the purpose of explaining the present disclosure, FIG. 1 illustrates that the case 50 is in the form of a pouch battery, but the scope of the present disclosure is not limited thereto, and the case 50 may include secondary batteries of any suitable shape, such as prismatic batteries and coin batteries.

The positive electrode 10, the negative electrode 20, and the separator 30 may be impregnated with an electrolyte. For example, the electrode assembly 40 may include electrode tabs 70, for example, a positive electrode tab and a negative electrode tab, which serve as an electrical path for guiding current to the outside. FIG. 1 illustrates that the electrode tab 70 has two tabs disposed on the same side surface, but the present disclosure is not limited thereto. In some embodiments, the positive electrode tab and the negative electrode tab may be disposed on different side surfaces.

In some embodiments, the positive electrode 10 and the negative electrode 20 may include a coated portion, which is a region where an active material is applied to a current collector (or a substrate) formed of a thin metal foil, and an uncoated portion, which is a region where an active material is not applied. The positive electrode 10 and the negative electrode 20 may be wound with the separator 30, which is an insulator, therebetween. The negative electrode 20 may be formed of copper (Cu), and the positive electrode 10 may be formed of aluminum (Al).

The protection member 12 may be disposed between the positive electrode 10 and the separator 30 to prevent or substantially reduce the likelihood of cracks in the electrode. The protection member 12 may be disposed between the negative electrode 20 and the separator 30 to prevent or substantially reduce the likelihood of cracks in the electrode. Although only one protection member 12 is illustrated in FIG. 1, one or more protection members 12 may be installed elsewhere as desired, and there is no particular limitation on the number of protection members.

The secondary battery 1000 according to some embodiments of the present disclosure may be applied to automobiles, mobile phones, and/or various types of electrical devices, and the present disclosure is not limited thereto.

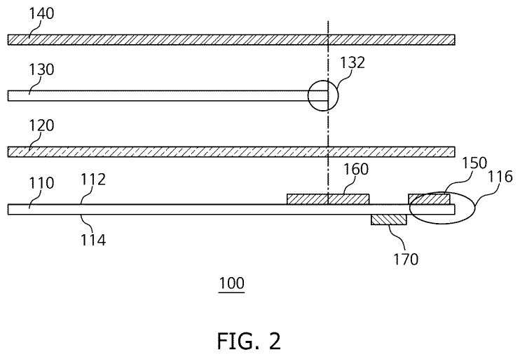

FIG. 2 illustrates a plan view schematically showing the electrode assembly 100 before being wound according to some embodiments of the present disclosure. For example, FIG. 2 illustrates the electrode assembly 100 according to some embodiments before being wound, when viewed from the x-axis direction of FIG. 1.

The electrode assembly 100 may include a first electrode 110, an outer separator 120 disposed on the first electrode 110, a second electrode 130 disposed on the outer separator 120, and an inner separator 140 disposed on the second electrode 130.

The first electrode 110 may be an electrode corresponding to the positive electrode or the negative electrode in the secondary battery. The second electrode 130 may be an electrode having an opposite polarity to the first electrode 110. For example, in examples in which the first electrode 110 is a positive electrode, the second electrode 130 may be a negative electrode. In examples in which the first electrode 110 is a negative electrode, the second electrode 130 may be a positive electrode.

The protection member 150 may be disposed on an end 116 of one side of the first electrode 110. According to some embodiments, the protection member 150 may be a tape including an adhesive. For example, the tape may include any one of polypropylene (PP), polyimide (PI), polyethylene propylene (PEP), or any combination thereof. However, the tape constituting the protection member 150 of the present disclosure is not limited to the above-described material, and may include various electrically insulating materials with excellent durability.

The adhesive may include any one of a polymer adhesive including acrylic or rubber, a liquid adhesive, a double-sided tape, or any combination thereof. The adhesive is not limited to that described above, and may include various electrically insulating materials with excellent adhesive properties. The protection member 150 may be a tape formed of a self-adhesive material that does not require a separate adhesive, and may be determined by those skilled in the art according to the desired characteristics and the environment of use of the secondary battery.

According to some embodiments, the protection member 150 may be disposed on the inner surface 112 of the first electrode 110 facing the outer separator 120. In examples in which the protection member 150 is disposed on the outer surface 114 of the first electrode 110, the protection member 150 may overlap a lower tape that maintains the electrode assembly 100 in the wound state. Therefore, the protection member 150 may be disposed on the inner surface 112 of the first electrode 110 facing the outer separator 120. According to some other embodiments, the protection member 150 may be disposed on the outer surface 114 of the first electrode 110.

The electrode assembly 100 according to some embodiments of the present disclosure may further include a first electrode tab 170 disposed on the outer surface 114 of the first electrode 110. A second electrode tab may be attached to one side surface of the second electrode 130. The position where the first electrode tab 170 is attached may be an uncoated portion of the first electrode 110 where the active material is not applied. For example, the position where the second electrode tab is attached may be an uncoated portion of the second electrode 130 where the active material is not applied.

The first electrode tab 170 may be an electrode corresponding to the positive electrode tab or the negative electrode tab in the secondary battery. For example, the second electrode tab may be an electrode tab having a polarity opposite to the first electrode tab 170. In examples in which the first electrode tab 170 is a positive electrode, the second electrode tab may be a negative electrode. In contrast, in examples in which the first electrode tab 170 is a negative electrode, the second electrode tab may be a positive electrode.

The electrode assembly 100 according to some embodiments of the present disclosure may further include an insulating member 160, which may be disposed on the inner surface 112 of the first electrode. The insulating member 160 may include a ceramic or a polymer material such as tape-shaped polyvinyl chloride (PVC), polytetrafluoroethylene (PTFE or Teflon), polyethylene (PE), epoxy resin, silicone, polyvinylidene fluoride (PVDF), polypropylene (PP), polyacrylonitrile (PAN), polyethylene oxide (PEO), or the like. However, the present disclosure is not limited thereto, and the insulating member 160 may include any one of appropriate compounds used as an insulating material. The thickness of the insulating member 160 may be equal to or similar to the thickness of the protection member 150.

According to some embodiments, the insulating member 160 may face an end 132 of one side of the second electrode 130 with the outer separator 120 therebetween. For example, the end 132 of one side of the second electrode 130 may be electrically insulated from the first electrode 110 by the outer separator 120 and the insulating member 160. This configuration may prevent or substantially reduce the likelihood of a short circuit in the first electrode 110 and the end 132 of one side of the second electrode 130 in a situation in which the length of the second electrode 130 extends due to charging and discharging of the secondary battery, a situation in which the outer separator 120 is damaged or short-circuited due to long-term use of the secondary battery, and a situation in which the length of the outer separator 120 is shortened due to charging and discharging of the secondary battery.

According to some embodiments, the second electrode 130 may be shorter in length than the first electrode 110, the inner separator 140, and the outer separator 120. Due to such a configuration, even in examples in which the electrode assembly 100 is wound, the inner separator 140 and the outer separator 120 surround the end 132 of one side of the second electrode 130 so as not to be exposed to the outside. Accordingly, it is possible to maintain an electrically insulated state from the first electrode 110 positioned on the top or bottom surface.

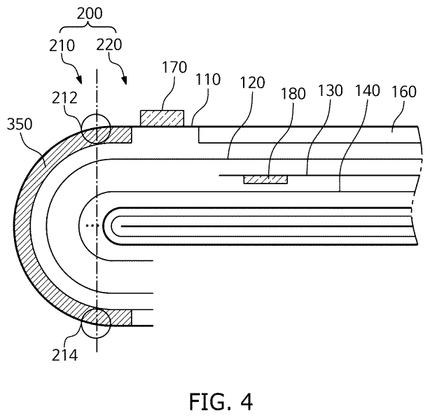

The electrode assembly 100 is wound with the first electrode 110 on the outside. For example, the position of the protection member 150 may belong to the curved portion of the wound first electrode 110. The detailed position of the protection member 150 is described further below with reference to FIGS. 3 and 4.

FIG. 3 illustrates a plan view showing a cross section of an electrode assembly according to some embodiments of the present disclosure. For example, FIG. 3 illustrates the electrode assembly according to some embodiments after being wound, when viewed from the x-axis direction of FIG. 1.

Referring to FIG. 3, a wound electrode assembly 200 according to some embodiments may include a curved portion 210 and a flat portion 220. The curved portion 210 may correspond to opposite round side surfaces of the wound electrode assembly 200. The curved portion 210 is a portion having a curvature in the electrode assembly 200 and may refer to a portion where force is applied to wind the electrode assembly 200 with a flat shape and tension in different directions is generated. The flat portion 220 is a portion of the electrode assembly 200 having no curvature and may refer to a portion has a tension in a certain size and direction and is not the curved portion 210.

According to some embodiments, the position of the protection member 150 may belong to the curved portion 210 of the wound first electrode 110. As the electrode assembly 200 is wound, a change in internal tension may occur at a boundary between the curved portion 210 and the flat portion 220 or at a starting point of the curved portion 210. Because the entire curved portion 210 receives a higher stress than the flat portion 220, cracks may be prevented or the likelihood thereof may be substantially reduced by separately disposing the protection member 150 at the corresponding position. The length of the protection member 150 is described further below with reference to FIG. 4.

According to some embodiments, the protection member 150 may not overlap the first electrode tab 170 with respect to the cross section of the wound electrode assembly 200. The protection member 150 and the first electrode tab 170 may be respectively disposed on opposite surfaces of the electrode. For example, the protection member 150 and the first electrode tab 170 may not overlap each other in the length direction of the electrode or may not overlap each other in the thickness direction of the electrode. The protection member 150 and the first electrode tab 170 may not overlap each other in the length direction and the thickness direction of the electrode.

Although FIG. 3 illustrates that the protection member 150 is positioned on the inner surface of the first electrode 110 and the first electrode tab 170 is positioned on the outer surface of the first electrode 110, the present disclosure is not limited thereto. For example, one end of the protection member 150 in the winding direction and one end of the first electrode tab 170 in the winding direction may be spaced apart from each other by the outer separator 120 or by empty space.

According to some embodiments, the end of one side of the second electrode 130 may overlap the insulating member 160 with respect to the cross section of the wound electrode assembly 200. For example, the end of one side of the second electrode 130 may overlap the insulating member 160 in the thickness direction of the electrode. The end of one side of the second electrode 130 may be electrically insulated from the first electrode 110 by the outer separator 120 and the insulating member 160 in the same manner as before the electrode assembly is wound, even after the electrode assembly is wound.

According to some embodiments, the electrode assembly 200 may further include a second electrode tab 180 disposed on one surface of the second electrode 130, and the second electrode tab 180 may overlap the insulating member 160 with respect to the cross section of the wound electrode assembly 200. For example, the second electrode tab 180 may overlap the insulating member 160 in the thickness direction of the electrode. In FIG. 3, the second electrode tab 180 is illustrated as being disposed on one surface facing the inner separator 140. However, the second electrode tab 180 may be disposed on one surface facing the outer separator 120.

FIG. 4 illustrates a plan view showing a cross section of an electrode assembly according to some other embodiments of the present disclosure.

Referring to FIG. 4, the protection member 350 according to some embodiments may be disposed from a position spaced approximately 5 mm or more from a starting point 212 of the curved portion to an ending point 214 of the curved portion. For example, the protection member 350 may be disposed from a position spaced 5 mm or more from the starting point 212 of the curved portion in the direction of the flat portion 220 to the ending point 214 of the curved portion. However, the separation distance is not limited to 5 mm, and may vary depending on the size and design of the secondary battery within a range that does not overlap with the first electrode tab 170.

In some other embodiments, the protection member 350 may be disposed from a position spaced a certain distance or more from the starting point 212 of the curved portion in the direction of the flat portion 220 to one end of the first electrode plate. In some other embodiments, the protection member 350 may be disposed from a position spaced a certain distance or more from the starting point 212 of the curved part in the direction of the flat portion 220 to a position spaced a certain distance or more from the ending point 214 of the curved part in the direction of the flat portion 220. To form uniform stress throughout the curved portion 210, the distance spaced from the starting point 212 of the curved portion in the direction of the flat portion 220 may be equal to the distance spaced from the ending point 214 of the curved portion in the direction of the flat portion 220. Accordingly, the protection member may be positioned throughout the curved portion 210.

According to some embodiments, the length of the protection member may be about 20 mm to about 24 mm. However, the length of the protection member is not limited thereto, and may vary depending on the size and design of the secondary battery within the range described above.

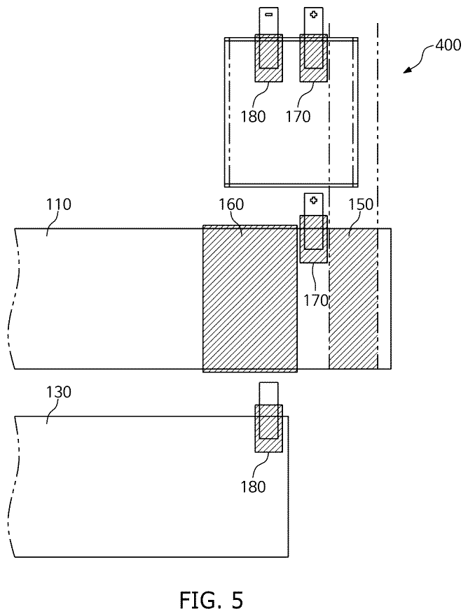

FIG. 5 illustrates an expanded view of the first electrode 110 and the second electrode 130 according to some embodiments of the present disclosure. For example, FIG. 5 illustrates the developed state of the first electrode 110 and the second electrode 130 according to some embodiments, when viewed from the z-axis direction of FIG. 1.

Referring to FIG. 5, the protection member 150 according to some embodiments of the present disclosure may be disposed in the entire region of the electrode width direction (e.g., the x-axis direction in FIG. 1). That is, the protection member 150 may be disposed across the first electrode 110 in the width direction along a portion where the end of one side of the first electrode 110 is bent. Accordingly, the width of the protection member 150 may correspond to the width of the first electrode 110.

The length of the protection member 150 may variously change to cover the end of one side of the first electrode within a range that does not overlap the first electrode tab 170. For example, the length of the disposed protection member 150 may be determined according to the size of the battery including the electrode assembly. For example, as the thickness of the battery increases, the length of the curved portion of the electrode assembly may increase and the length of the protection member 150 may increase accordingly.

The insulating member 160 according to some embodiments of the present disclosure may be disposed in the entire region of the electrode width direction in a shape similar to that of the protection member 150. That is, the insulating member 160 may be disposed across the first electrode 110 in the width direction. Accordingly, the width of the insulating member 160 may correspond to the width of the first electrode 110.

In some embodiments, the second electrode tab 180 may overlap the insulating member 160. For example, the second electrode tab 180 may overlap the insulating member 160 in the thickness direction of the electrode (e.g., the radial direction of the electrode assembly 200) while the electrode is wound. The length of the insulating member 160 may be longer than the distance designed to separate the second electrode tab 180 from the first electrode tab 170. For example, the insulating member 160 may be disposed from a position spaced apart from the first electrode tab 170 so as to prevent the peripheral portion of the first electrode tab 170 from becoming too thick.

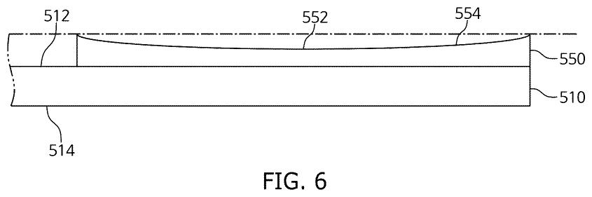

FIG. 6 illustrates a plan view showing a cross section of a protection member 550 according to some embodiments of the present disclosure. For example, FIG. 6 illustrates the protection member 550 according to some embodiments, when viewed from the x-axis direction of FIG. 1.

Referring to FIG. 6, the protection member 550 according to some embodiments may include a central portion 552 and an outer portion 554. In examples in which the electrode assembly is wound around the protection member 550, the central portion 552 of the protection member 550 may be positioned at the center of the curved portion of the electrode assembly, and the outer portion 554 of the protection member 550 may be positioned outside the curved portion. For example, at the center of the curved portion, the inner surface 512 of the first electrode is shortened the most, and the outer surface 514 of the first electrode is extended the most. In contrast, around the curved portion, the inner surface 512 of the first electrode and the outer surface 514 of the first electrode are not greatly shortened or extended. That is, in examples in which the electrode assembly including the protection member 550 is wound, the central portion 552 positioned in the center of the curved portion of the electrode assembly is greatly shortened and thickened, and the outer portion 554 positioned outside the curved portion is shortened relatively little and does not have a relatively large change in thickness.

According to some embodiments, the thickness of the protection member 550 may become thicker as the distance from the central portion 552 of the protection member increases toward the outer portion 554 along the winding direction (e.g., the y-axis in FIG. 1). Due to such a configuration, the thicknesses of the central portion 552 and the outer portion 554 of the protection member 550 are made different. Accordingly, after the electrode is wound, the thickness of the protection member 550 may be kept equal for all curved surfaces, and the amount of tension applied to the electrode assembly may be maintained uniformly. For example, cracks occurring in the electrode assembly may be effectively prevented or the likelihood thereof may be substantially reduced.

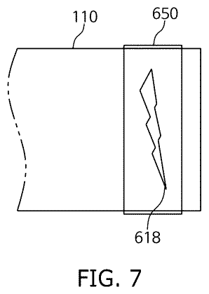

FIGS. 7 to 9 illustrate a first electrode and a protection member according to some embodiments of the present disclosure.

Referring to FIG. 7, cracks 618 that occur in the first electrode 110 initially develops in the center of the first electrode 110 and then propagates. Therefore, in order to prevent or substantially reduce the likelihood of the occurrence of the cracks 618, the protection member 650 of the present disclosure may be disposed with respect to the center of the first electrode 110.

The protection member 650 according to some embodiments may be disposed in the entire region of the electrode width direction. That is, the protection member 150 may be disposed across the first electrode 110 in the width direction along a portion (e.g., a curved portion) where the end of one side of the first electrode 110 is bent.

Due to such a configuration, the protection member may be disposed on the curved portion where cracks are continuously found during the charging and discharging process of the secondary battery, thereby preventing the occurrence of cracks or substantially reducing the likelihood thereof and improving the durability and lifespan of the electrode assembly.

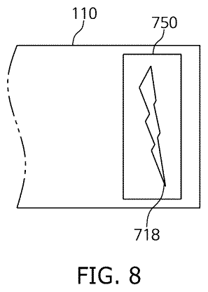

Referring to FIG. 8, even in examples in which a protection member 750 is not attached to opposite end portions of the first electrode 110, the initial occurrence of cracks 718 is not affected, and thus, the protection member 750 may be designed to be spaced apart from opposite end portions of the first electrode 110. According to such a configuration, because the material cost of the protection member 750 may be reduced and the protection member 750 does not need to be attached to the upper and lower end portions of the first electrode 110, it is possible to obtain an effect of facilitating assembling and reducing the manufacturing process time and cost of the electrode assembly.

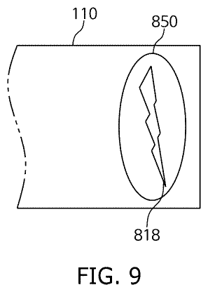

Referring to FIG. 9, the shape of the protection member 850 is not limited to a rectangular shape. The shape of the protection member 850 may be freely modified as long as the protection member 850 satisfies the condition of being disposed at the central portion of the first electrode 110 so as to prevent or substantially reduce the likelihood of cracks 818. For example, the protection member 850 may have an elliptical shape. For example, the protection member 850 according to some embodiments may have an elliptical shape in which the length of the major axis is equal to or greater than 70% of the width of the first electrode 110 and the length of the minor axis is about 20 mm to about 24 mm.

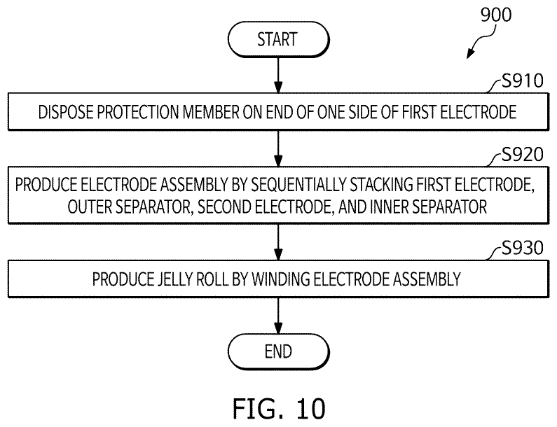

FIG. 10 illustrates a flowchart showing an example of a method for manufacturing an electrode assembly according to the present disclosure.

The method 900 of manufacturing the electrode assembly according to some embodiments may be started by disposing a protection member on an end of one side of a first electrode (S910). The protection member may be disposed on an inner surface of the first electrode facing an outer separator. The protection member may be disposed in the entire region of the electrode in the width direction.

According to some embodiments, the protection member may be a tape including an adhesive. The tape may include any one of PP, PI, PEP, or any combination thereof. For example, the protection member may include a central portion and an outer portion, and the thickness of the protection member may become thicker as the distance from the central portion increases toward the outer portion along the winding direction.

Thereafter, the electrode assembly may be produced by sequentially stacking the first electrode, an outer separator, a second electrode, and an inner separator (S920). The second electrode may be shorter than the first electrode and the separator.

According to some embodiments, the electrode assembly may further include an insulating member, and the insulating member may be disposed on the inner surface of the first electrode. The insulating member may face the end of one side of the second electrode with the outer separator therebetween.

Thereafter, the jelly roll may be produced by winding the electrode assembly (S930). The position of the protection member may belong to the curved portion of the wound first electrode. For example, according to some embodiments, the protection member may be positioned on the entire curved portion. The protection member may be disposed from a position spaced 5 mm or more from the starting point of the curved portion to the ending point of the curved portion. The length of the protection member may be about 20 mm to about 24 mm.

According to some embodiments, the electrode assembly may further include a first electrode tab, and the protection member may not overlap the first electrode tab with respect to the cross section of the wound electrode assembly.

The electrode assembly may further include a second electrode tab disposed on one surface of the second electrode. The end of one side of the second electrode may overlap the insulating member with respect to the cross section of the wound electrode assembly.

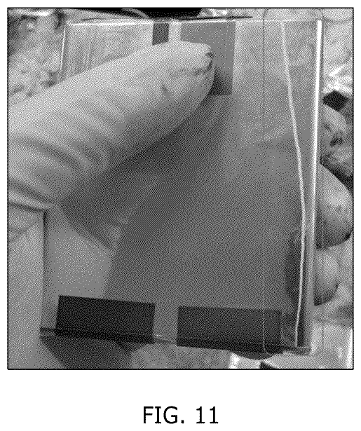

FIG. 11 illustrates cracks (damage) occurring in a secondary battery.

Referring to FIG. 11, in a secondary battery, in particular, a lithium-ion battery, a charging and discharging process occurs due to the movement of lithium ions between an electrolyte and an electrode. During this process, the electrode undergoes a physical change in volume as the electrode absorbs or releases lithium ions. Such a contraction and expansion phenomena may cause problems that may significantly affect the life and performance of the battery. For example, in an electrode assembly wound and inserted into a case of a secondary battery, electrodes positioned on the outside of the electrode assembly may receive non-uniform mechanical stress due to contraction and expansion of the electrode assembly. It may be confirmed that, as tension increases, the electrode on the outer portion is stretched and cracks occur in the bent portion positioned on the side.

In the long term, these cracks may cause internal disconnection or separation between layers, leading to reduced battery performance or shortened lifespan, and may further significantly reduce the safety and reliability of the battery.

However, the present disclosure is not limited to the above embodiment, and the case may be configured in various shapes, such as a circular shape and a pouch shape. Further, the case may be made of a metal, such as aluminum, aluminum alloy, or nickel-plated steel, a laminated film, or plastic (e.g., in a pouch-type embodiment).

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

### DESCRIPTION OF SOME OF THE REFERENCE SYMBOLS

100: electrode assembly
110: first electrode
112: inner surface of first electrode
114: outer surface of first electrode
116: end of one side of first electrode
120: outer separator
130: second electrode
132: one end of one side of second electrode
140: inner separator
150: protection member
160: Insulating member
170: first electrode tab

What is claimed is:

1. An electrode assembly comprising:
a first electrode;
an outer separator on the first electrode;
a second electrode on the outer separator; and
an inner separator on the second electrode,
wherein a protection member is at an end of one side of the first electrode, and a position of the protection member is at a curved portion of the first electrode in a wound state.

2. The electrode assembly as claimed in claim 1, wherein the protection member is on an inner surface of the first electrode facing the outer separator.

3. The electrode assembly as claimed in claim 1, wherein the protection member is positioned over an entirety of the curved portion of the first electrode.

4. The electrode assembly as claimed in claim 1, wherein the protection member extends from a position spaced 5 mm or more from a starting point of the curved portion to an ending point of the curved portion.

5. The electrode assembly as claimed in claim 1, wherein a length of the protection member is about 20 mm to about 24 mm.

6. The electrode assembly as claimed in claim 1, wherein the protection member is positioned over an entire region of the first electrode in a width direction.

7. The electrode assembly as claimed in claim 1, wherein the protection member comprises a central portion and an outer portion, and
wherein a thickness of the protection member increases as a distance from the central portion increases toward the outer portion along a winding direction.

8. The electrode assembly as claimed in claim 2, further comprising a first electrode tab on an outer surface of the first electrode.

9. The electrode assembly as claimed in claim 8, wherein the protection member does not overlap the first electrode tab with respect to a cross section of the electrode assembly wound therearound.

10. The electrode assembly as claimed in claim 2, further comprising an insulating member on the inner surface of the first electrode.

11. The electrode assembly as claimed in claim 10, wherein the insulating member faces an end of one side of the second electrode with the outer separator therebetween.

12. The electrode assembly as claimed in claim 11, wherein the second electrode is shorter than the first electrode and the separator.

13. The electrode assembly as claimed in claim 12, wherein an end of one side of the second electrode overlaps the insulating member with respect to a cross section of the electrode assembly wound therearound.

14. The electrode assembly as claimed in claim 13, further comprising a second electrode tab on one surface of the second electrode,
wherein the second electrode tab overlaps the insulating member with respect to the cross section of the electrode assembly wound therearound.

15. The electrode assembly as claimed in claim 1, wherein the protection member is a tape comprising an adhesive.

16. The electrode assembly as claimed in claim 15, wherein the tape comprises any one of polypropylene (PP), polyimide (PI), polyethylene propylene (PEP), or any combination thereof.

17. A secondary battery comprising the electrode assembly as claimed in claim 1.

18. A method of manufacturing an electrode assembly the method comprising:
positioning a protection member on an end of one side of a first electrode;
producing the electrode assembly by sequentially stacking the first electrode, an outer separator, a second electrode, and an inner separator; and
producing a jelly roll by winding the electrode assembly,
wherein a position of the protection member is at a curved portion of the first electrode in a wound state.

19. The method as claimed in claim 18, wherein the protection member comprises a central portion and an outer portion, and
wherein a thickness of the protection member increases as a distance from the central portion increases toward the outer portion along a winding direction.

20. The method as claimed in claim 18, wherein the electrode assembly further comprises a first electrode tab, and
wherein the protection member does not overlap the first electrode tab with respect to a cross section of the electrode assembly wound therearound.
